(19) United States
(12) Patent Application Publication
(10) Pub. No.: US 2014/0288901 A1
(43) Pub. Date: Sep. 25, 2014

(54) COMPUTER-AIDED DIE DESIGN APPARATUS

(71) Applicant: HONDA MOTOR CO., LTD., Tokyo (JP)

(72) Inventors: Masatoshi Kobayashi, Wako-shi (JP); Daiya Yamashita, Wako-shi (JP); Yoshifumi Yamaguchi, Wako-shi (JP)

(73) Assignee: HONDA MOTOR CO., LTD., Tokyo (JP)

(21) Appl. No.: 14/222,890

(22) Filed: Mar. 24, 2014

(30) Foreign Application Priority Data
Mar. 25, 2013 (JP) 2013-062209

(51) Int. Cl. G06F 17/50

(52) U.S. Cl. CPC G06F 17/5009
USPC 703/2; 703/9

(57) ABSTRACT

In a computer-aided die design apparatus having a computer, a display adapted to be connected to the computer, and a simulator adapted to be loaded in the computer to analyze and display on the display flow behavior of resin when the resin charged into a die cavity is die-clamped by a press at a compression force, the simulator comprises an analyzer that analyzes the resin flow behavior by increasing the compression force for die-clamping the resin at a predetermined time interval until the increased compression force reaches an upper limit value, and a substitutive value calculator that calculates a substitutive value of the compression force based on a stress-relaxation time of the resin when the compression force has reached the upper limit value.

### TECHNICAL FIELD

Embodiments of this invention relate to a die design apparatus using computer-aided engineering.

### RELATED ART

A known technology concerning a computer-aided die design apparatus is described, for example, in Reference (Japanese Laid-Open Patent Application No. Hei 9(1997)-76267). This technology is configured to simulate the flow behavior of a flowable resin during molding by a press molding process.

More specifically, the technology described in Reference is configured to successively calculate the compression speed (die-clamping speed) received by a resin based on hydraulic circuit characteristics, press-device-side elasticity and resin-side apparent elasticity, and analyze the resin flow behavior based on the calculated compression speed. In other words, the technology described in Reference is configured to avoid the inconvenience of the error that has conventionally arisen in the analysis owing to the compression speed being considered constant and therefore differing from the actual value.

### SUMMARY

The configuration of the technology described in Reference improves the calculation accuracy of the compression speed, but it assumes that die-clamping is finished and terminates the analysis immediately after the compression speed becomes zero, so that it still has a drawback in the point of insufficient accuracy of the resin flow behavior analysis.

Therefore, the embodiments of this invention is directed to overcoming the foregoing problem by providing a computer-aided die design apparatus that achieves improved accuracy of resin flow behavior analysis by accurately determining completion of die-clamping.

In order to achieve the object, embodiments of this invention provides in its first aspect a computer-aided die design apparatus having a computer, a display adapted to be connected to the computer, and a simulator adapted to be loaded in the computer to analyze and display on the display flow behavior of resin when the resin charged into a die cavity is die-clamped by a press at a compression force, wherein the simulator comprises: an analyzer that analyzes the resin flow behavior by increasing the compression force for die-clamping the resin at a predetermined time interval until the increased compression force reaches an upper limit value; and a substitutive value calculator that calculates a substitutive value of the compression force based on a stress-relaxation time of the resin when the compression force has reached the upper limit value.

In order to achieve the object, the embodiment of this invention provides in its second aspect a computer-aided die design apparatus having a computer, a display adapted to be connected to the computer, and a simulation program adapted to be loaded in the computer to analyze and display on the display flow behavior of resin when the resin charged into a die cavity is die-clamped by a press at a compression force, wherein the simulation program is programmed to analyze the resin flow behavior by increasing the compression force for die-clamping the resin at a predetermined time interval until the increased compression force reaches an upper limit value; and calculate a substitutive value of the compression force based on a stress-relaxation time of the resin when the compression force has reached the upper limit value.

### BRIEF DESCRIPTION OF THE DRAWINGS

FIG. 1 is an overall schematic view of a computer-aided die design apparatus according to a first embodiment of this invention;

FIG. 2 is an explanatory diagram showing a series of processes from product design to volume production in which the apparatus of FIG. 1 is used;

FIG. 3 is an explanatory view of a die assembly model shown in FIG. 2;

FIG. 4 is a flowchart showing the operations of the computer-aided die design apparatus shown in FIG. 1;

FIG. 5 is an explanatory diagram for explaining the operations of the flowchart of FIG. 4;

FIG. 6 is a flowchart, similar to the flowchart of FIG. 4, showing operations of a computer-aided die design apparatus according to a second embodiment of this invention; and

FIG. 7 is an explanatory diagram showing die-clamping operation details for comparing the effect of the embodiments of this invention with the prior art.

### DESCRIPTION OF THE EMBODIMENTS

Embodiments for implementing a computer-aided die design apparatus according to this invention are explained with reference to the attached drawings in the following.

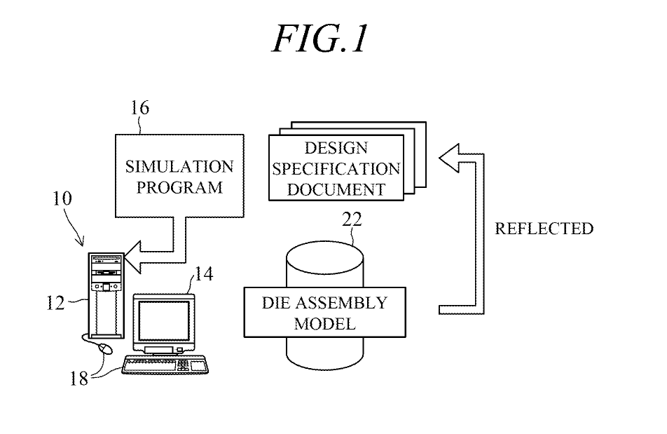

FIG. 1 is an overall schematic view of a computer-aided die design apparatus according to a first embodiment of this invention.

Reference symbol 10 in FIG. 1 designates the apparatus, and the apparatus 10 comprises a computer 12, a display 14 connected to the computer 12, an interactive simulation program (sumulator) 16 loaded in the computer 12 that analyzes and displays on the display 14 resin flow behavior when resin charged into a die cavity is die-clamped by a press at a compression force F, and input devices 18 such as a keyboard, mouse and the like.

Thus, the apparatus 10 is configured as a die design apparatus utilizing CAE (Computer Aided Engineering), CAD (Computer Aided Design)/CAM (Computer Aided Manufacturing), or CIM (Computer Integrated Manufacturing).

In concrete terms, die design is performed as one part of a series of processes extending from product design to volume production, wherein a design engineer uses the input devices 18 to input data into the computer 12 in accordance with a design specification document setting out required product specifications and interactively designs a product model 20 following instructions incorporated in the program 16.

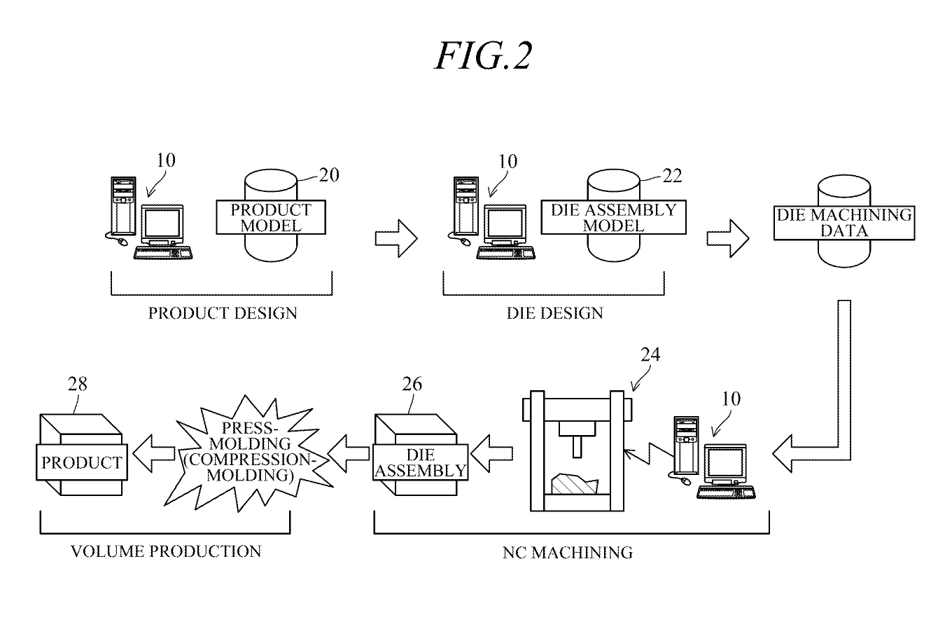

FIG. 2 is an explanatory diagram showing a series of processes from product design to volume production in which the apparatus 10 is used.

In CAE, when a product 28 is to be manufactured using a die assembly 26, the engineer first uses the apparatus 10 to design the product model 20 in a product design step and uses the created product model 20 to design a die assembly model 22.

Next, the engineer uses the created die assembly model 22 to generate die machining data, uses the data to make the die assembly 26 with an NC machining device 24 or the like, and manufactures the product 28 by press-molding (compression-molding) using the die assembly 26. If the die assembly model 22 creation results are incorporated in the design specifications at this time, they are reflected in the design of the next die assembly.

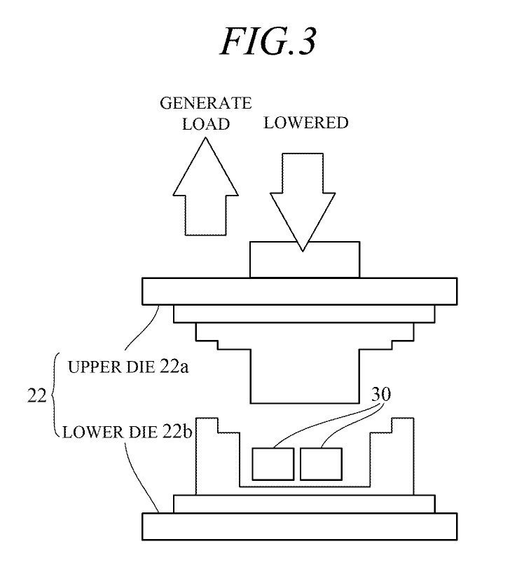

FIG. 3 is an explanatory diagram showing the designed die assembly model 22. As illustrated, the die assembly model 22 is equipped with an upper die 22a and a lower die 22b, and a cavity (void) is formed in the lower die 22b and configured to enable charging of a material (resin) 30 therein. The resin comprises, for example, polypropylene, polyamide, polyester, polycarbonate or other thermoplastic resin, or epoxy, unsaturated polyester or other thermosetting resin, or a fiber-reinforced resin or the like obtained by reinforcing one of these with glass fiber, carbon fiber or the like, and in the illustrated example it is charged in sheet form (in a semifused state).

The upper die 22a of the die assembly model 22 is configured to be vertically movable by a press (not shown). When the upper die 22a is lowered (die-clamped), the resin 30 is compressed and a load (reaction force; compression force F) occurs.

The object of this embodiment is to compress the material (resin) 30 in the die assembly model 22, analyze the flow behavior of the resin and design the die assembly 26, so the following explanation will focus on this point.

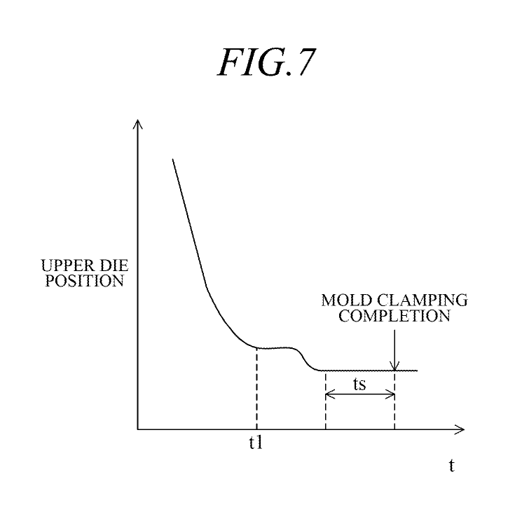

A problem to be solved by this embodiment is again explained with reference to FIG. 7. FIG. 7 is an explanatory diagram showing die-clamping operation details for comparing the effect of the embodiment with the prior art.

As illustrated, when an external force is applied to a resin or other material having viscoelasticity, the stress acting inside the material decreases with passage of time in what is called a stress-relaxation phenomenon, so that in an actual molding process, compression occurs again together with stress-relaxation phenomenon even after the compression force once reaches the upper limit value and the die-clamping speed (compression speed) becomes zero.

In the technology described in Reference, when the upper die of the die assembly once stops at time t1, i.e., when the die-clamping speed becomes zero, analysis is finished on the assumption that the die-clamping has stopped. In other words, the failure to take resin stress-relaxation phenomenon into account leads to the disadvantage of inadequate analysis accuracy.

With consideration to this point, this embodiment is configured to calculate a substitutive value Fa of the compression force F based on the stress-relaxation time, so that the accuracy of the resin flow behavior analysis can be enhanced.

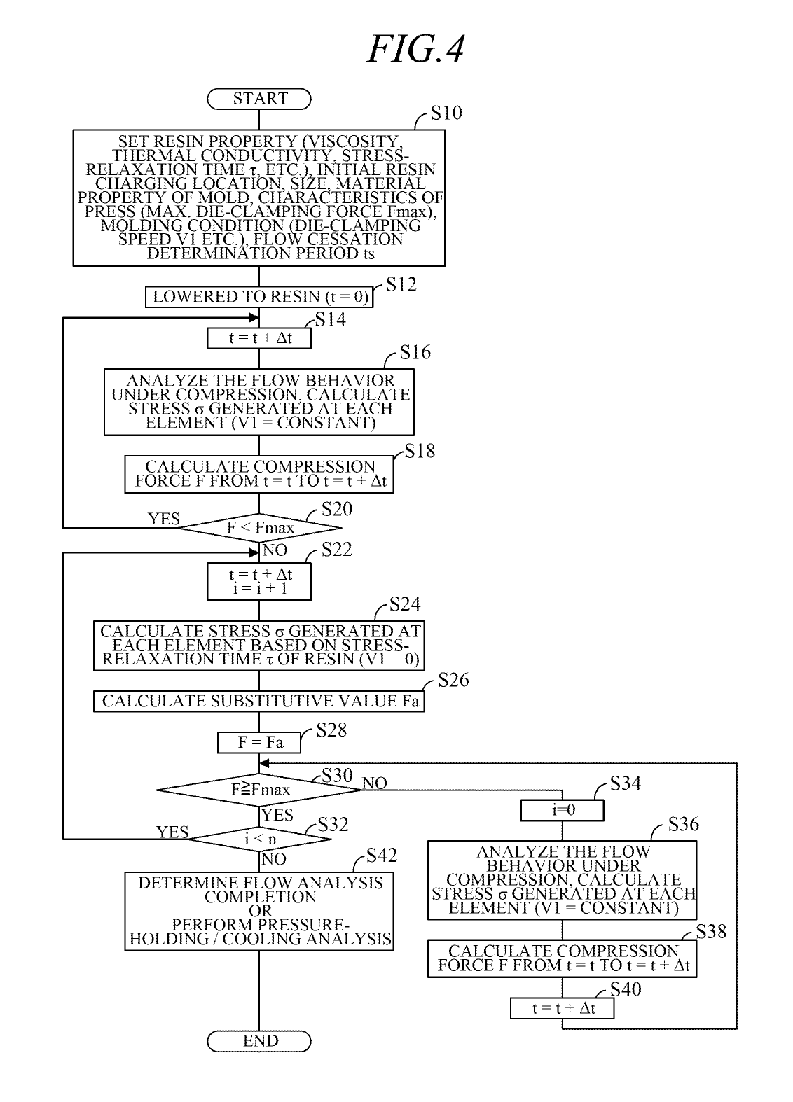

FIG. 4 is a flowchart showing the analysis procedure. This is an operation of the aforesaid simulation program 16.

Now to explain, in S (Step) 10, initial conditions like the ones listed are set. The processing in S10 amounts to analysis preparation work.

The physical properties defined for the resin 30 include viscosity, thermal conductivity, specific heat, specific volume, and stress-relaxation time. “Stress-relaxation time” means the time constant of the stress-relaxation phenomenon.

The initial resin charging location is the cavity of the lower die 22b, like that shown in FIG. 3, where the resin 30 is placed, and its dimensions are expressed as the size and thickness [cm] of the resin 30 in its initial state (before compression). Moreover, the temperature and the like of the resin 30 are also inputted.

The die material properties refer to, inter alia, the temperature and thermal conductivity of the material to be used in the die assembly model 22, and the volume of the cavity of the lower die 22b. The press properties include the maximum clamping force (upper limit value) Fmax [N] of the hydraulically powered or other type press to be used.

The molding conditions in the present embodiment refer to, inter alia, the die-clamping speed of the upper die 22a of the die assembly model 22 (descent speed or compression speed) V1 [cm/sec].

As explained later, the flow cessation determination period (predefined period) ts is a period used in determining completion of the resin flow behavior analysis, and is obtained empirically beforehand.

Next, in S12, the upper die 22a of the die assembly model 22 is lowered as far as the material (resin) 30 and analysis is started. The time t at this point is defined as t=0 (initial value). It is assumed here that at this time point the die-clamping speed V1 has reached the value set in S10.

Next, in S14, the time is updated by adding a predetermined time increment Δt to the time t (initial value 0), whereafter the program goes to S16, in which the flow behavior at that time (t+Δt) of the resin 30 under compression with the die-clamping speed V1 kept constant is analyzed, and the stress σ generated at each element of the resin 30 is calculated by the finite element method.

Next, in S18, the compression force F during the period from t=0 to t=t+Δt is calculated. This calculation is done by integrating the individual element stresses σ calculated in S16. Owing to the fact that the die-clamping speed V1 of the upper die 22a is maintained constant in the processing from S12 onward in the present embodiment, the thickness of the resin 30 is progressively reduced from the initial value at the rate of speed V1×predetermined time increment Δt.

Next, in S20, it is determined whether the compression force F calculated in S18 is less than the maximum clamping force (upper limit value) Fmax, and when the result is YES, the program returns to S14 to repeat the foregoing processing.

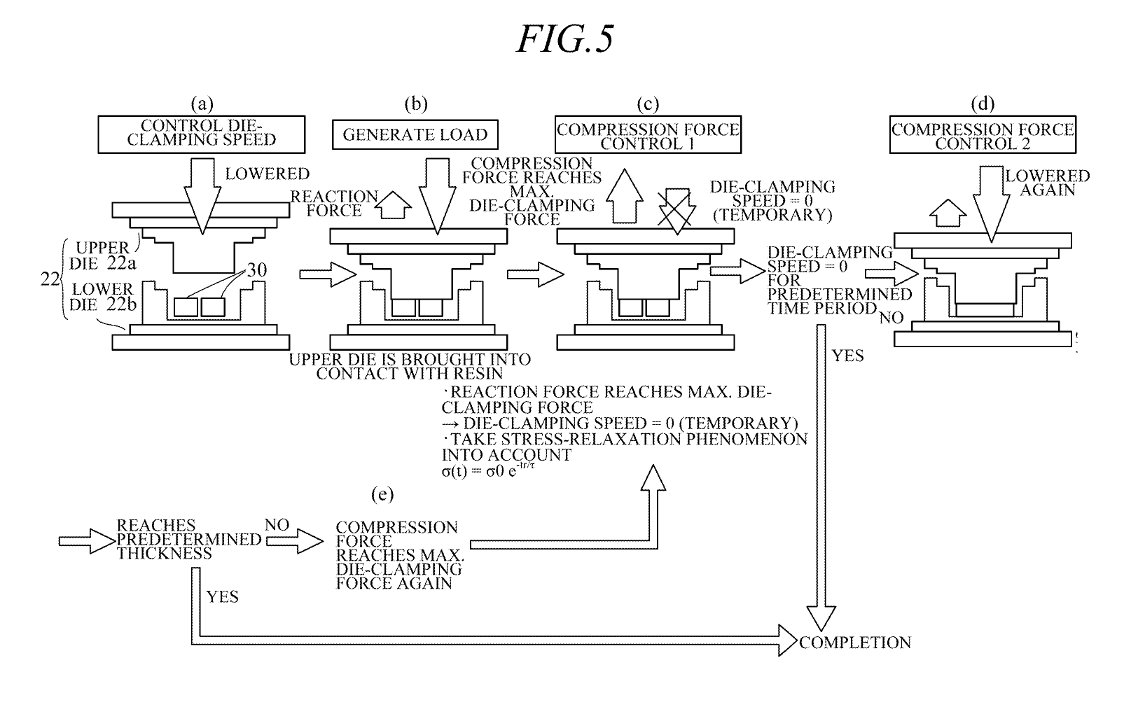

FIG. 5 is an explanatory diagram illustrating the processing of FIG. 4.

Before continuing the explanation of FIG. 4, a general explanation of the processing of FIG. 4 will be given here with reference to FIG. 5: In the processing of FIG. 4, first, as shown in FIG. 5(a), the upper die 22a is lowered and, as shown in FIG. 5(b), the upper die 22a is brought into contact with the resin 30 to generate the compression force (load) F (S12 of FIG. 4). The analysis is begun from time t=0 at this point.

Next, as shown in FIG. 5(c), the flow behavior of the resin 30 is analyzed while die-clamping the resin 30 by increasing the compression force F at a predetermined time interval Δt until the increased compression force F reaches the maximum die-clamping force (upper limit value) Fmax.

As mentioned with reference to FIG 7, once the compression force F reaches the maximum die-clamping force Fmax, the die-clamping speed V1 starts decreasing and eventually becomes zero. Since the technology recited in Reference terminates the analysis at this time on the assumption that die-clamping has ceased, it has the disadvantage of insufficient analysis accuracy because it cannot take the ensuing stress-relaxation phenomenon into account.

In view of this point, as shown from (c) to (e) in FIG. 5, this embodiment is configured so that when the compression force F reaches the maximum die-clamping force Fmax, the substitutive value (substitutive compression force) Fa of the compression force F is calculated based on the stress-relaxation time of the resin 30.

Further, a configuration is adopted wherein the compression force F is replaced with the substitutive value Fa after occurrence of the stress-relaxation phenomenon; the flow behavior of the resin 30 is analyzed while die-clamping the resin 30 by increasing the compression force F at the predetermined time interval Δt until the replaced compression force F reaches the maximum die-clamping force Fmax; and after it reaches the maximum die-clamping force Fmax, it is determined that the die-clamping have completed when the replaced compression force F is kept equal to or greater than the maximum die-clamping force for the predefined time period ts.

Returning to the explanation of the flowchart of FIG. 4 with the foregoing in mind, when the result in S20 is YES, the program returns to S14, and when it is NO, i.e., when it is determined that the compression force F has reached the maximum die-clamping force Fmax, the program goes to S22, in which the time t is updated by adding the predetermined time increment Δt, and the value of a count i (explained later) is incremented.

Next, in S24, the die-clamping speed V1 is temporarily set to zero (die-clamping is stopped), and the stress σ is calculated based on the stress-relaxation time of the resin 30. Specifically, the stress σ is calculated by the following Maxwell relational expression.

σ=σ0 exp (−tr/τ),

where σ0: stress at instant of die-clamping is stopped; τ: stress-relaxation time of resin 30; and tr: elapsed time period since the die-clamping was stopped, namely, the value obtained by multiplying the count i by the predetermined time increment Δt. Owing to the use of the elapsed time tr, the value of the stress σ decreases with each successive calculation. Here, “exp” in the foregoing stands for “exponential function.”

In the calculation of the stress σ based on the stress-relaxation time, it is possible to do the calculation without making die-clamping speed V1 exactly zero (i.e., die-clamping is stopped) but making it a very low value (more specifically, a zero equivalent value; V1≈0). In this case, in the aforesaid calculation formula of the stress σ based on the stress-relaxation time, it suffices if the following simultaneous equations hold.

σ=ηγ

σ0=η0γ,

where η: viscosity of the resin 30 at elapsed time tr from die-clamping cessation; η0: viscosity of the resin 30 at instant of making V1≈0, and γ: strain rate of the resin 30.

Next, in S26, the substitutive value (substitutive compression force) Fa of the compression force F at the current time t is calculated. This calculation is done by integrating the individual element stresses σ calculated in S24. The processing of S26 therefore amounts to calculating the substitutive value Fa of the compression force F based on the stress-relaxation time τ of the resin 30.

As cooling of the resin 30 by the die assembly itself can be anticipated, it is of course possible in calculating the substitutive value Fa to give consideration not only to the aforesaid relational expression but also to commonly applied temperature/time conversion rules.

Next, in S28, the compression force F is replaced with the substitutive value Fa, whereafter, in S30, it is determined whether the replaced compression force F is equal to or greater than the maximum die-clamping force Fmax. When the result in S30 is YES, the program goes to S32, in which it is determined whether the value of the count i is less than a specified value n. The specified value n is the value obtained by dividing the flow cessation determination period (predefined period) ts by the predetermined time increment Δt, so that the determination in S32 amounts to determining whether the elapsed time tr from die-clamping cessation (V1=0) has become equal to the flow cessation determination period ts.

In the first program loop, the result in the determination in S32 is ordinarily YES, so that the program returns to S22, in which the time t is updated by adding the predetermined time increment Δt and the value of the count i is incremented, and then goes to S24 and S26, in which the stress σ is recalculated and the substitutive value Fa is recalculated.

Since the elapsed time tr is used in the calculation of stress σ as explained above, the substitutive value Fa decreases with each succeeding calculation once the stress-relaxation phenomenon occurs, whereby the determination of S30 becomes NO, and the program goes to S34, in which the value of the count i is reset to 0, and to S36, in which the flow behavior at time t+Δt of the resin 30 with the die-clamping speed V1 kept constant is analyzed, and the stress σ generated at each element of the resin 30 is calculated.

Next, in S38, the compression force F is calculated from the stress determined in S36. It should be noted that the value calculated in S36-S38 is not the substitutive value Fa calculated in S26 based on the stress-relaxation time τ of the resin 30 but the compression force F calculated similarly to in S16-S18 based on the flow behavior of the resin 30 under recompression.

Next, in S40, the time t is updated, whereafter the program goes to S30 to repeat the foregoing processing. In other words, when the substitutive value Fa calculated based on the stress-relaxation time τ of the resin 30 (more exactly, the replaced compression force F) becomes less than the maximum die-clamping force Fmax, the upper die 22a is again lowered at the speed V1, and the flow behavior of the resin 30 is analyzed while die-clamping the resin 30 by increasing the compression force F at the predetermined time interval Δt until the increased compression force F reaches the maximum die-clamping force Fmax.

On the other hand, when the result in S32 is NO, i.e., when it is determined that the compression force F replaced with the substitutive value Fa is kept equal to or greater than the maximum die-clamping force Fmax for the flow cessation determination period ts, and, therefore, since flow of the resin 30 stops completely and die-clamping is determined to have reached completion, the program goes to S42, in which it is determined that flow analysis of the resin 30 has completed. Transition to pressure-holding/cooling analysis or the like is performed as required.

As the computer-aided die design apparatus 10 according to this embodiment is configured as explained above, it can determine die-clamping completion with high precision and thus enhance the accuracy of the flow behavior analysis of the resin 30.

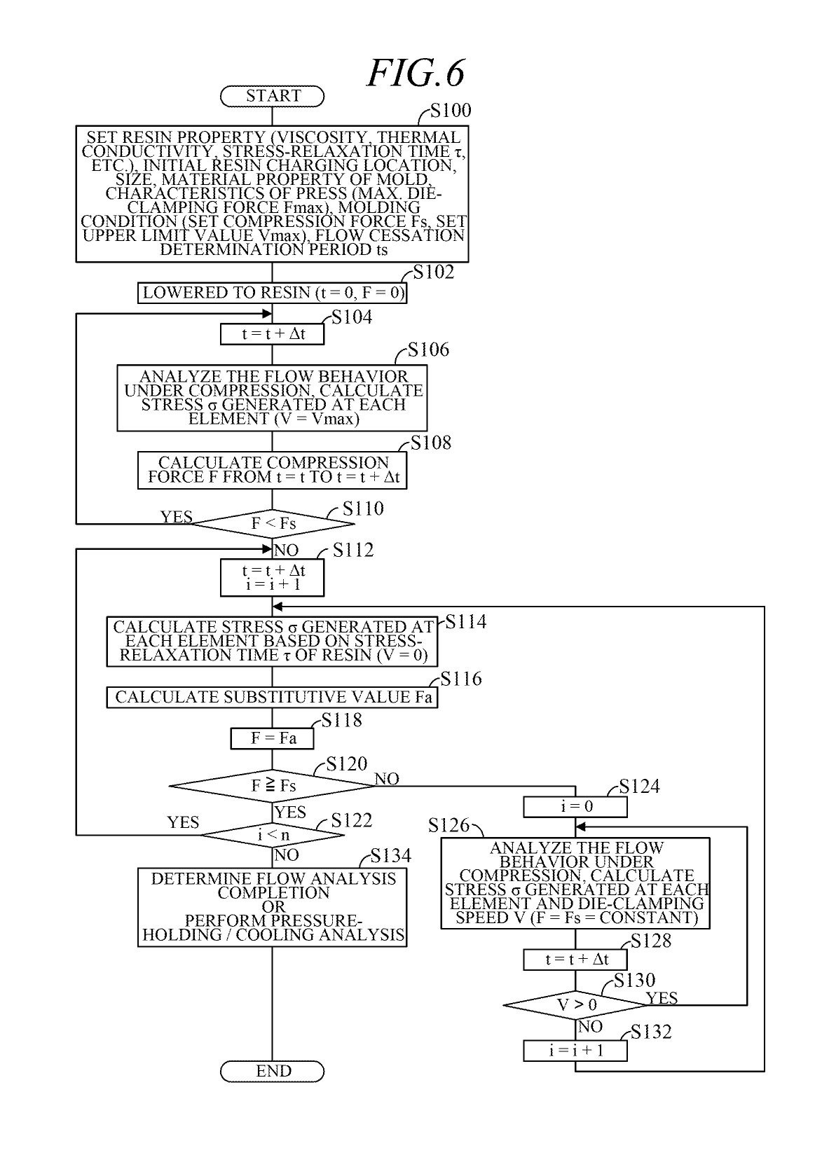

FIG. 6 is a flowchart, similar to that of FIG. 4, showing operations of the simulation program 16 of a computer-aided die design apparatus according to a second embodiment of this invention.

Processing steps that are common between the flowchart of FIG. 6 and the flowchart of FIG. 4 are not explained in detail and the following explanation is focused on the points of difference from the first embodiment.

The first embodiment is configured so that in the processing according to the flowchart of FIG. 4, the upper limit value Fmax is set at a fixed value (maximum die-clamping force) determined from the properties of the press, and the die-clamping speed of the upper die 22a is controlled to V1 until the compression force F reaches the upper limit value Fmax.

In contrast to this, the second embodiment is configured to set the upper limit value at an arbitrary value (set compression force) Fs equal to or less than the maximum die-clamping force determined from the properties of the press.

In the second embodiment, therefore, in S100, an arbitrary compression force (set compression force (upper limit value)) Fs [N] and an upper limit speed of the die-clamping speed V (set upper limit value) Vmax [cm/sec] are inputted as molding conditions instead of the maximum die-clamping force Fmax of the press and the constant die-clamping speed V1.

Next, in S102, the upper die 22a is lowered to the resin 30 and analysis is begun, while the compression force F at this time is set at F=0 (initial value). It is assumed here that at this time point the die-clamping speed V has reached the set upper limit value Vmax set in S100.

Next, the time is updated in S104, whereafter the program goes to S106, in which the flow behavior at that time (t+Δt) of the resin 30 under compression with the die-clamping speed V set at the set upper limit value Vmax is analyzed, and the stress σ generated at each element of the resin 30 is calculated by the finite element method.

Next, in S108, the compression force F is calculated based on the calculated stress σ, whereafter the program goes to S110, in which it is determined whether the compression force F calculated in S108 is less than the set compression force (upper limit value) Fs.

When the result in S110 is NO, i.e., when it is determined that the compression force F has reached the set compression force Fs, the program goes to S112, in which the time t is updated and the value of the count i is incremented, and to S114, in which the stress σ is calculated based on the stress-relaxation time τ similarly to in S24 of FIG. 4.

Next, in S116, the substitutive value (substitutive compression force) Fa of the compression force F at the current time t is calculated based on the stress σ calculated in 5114, whereafter the program goes to S118, in which the compression force F is replaced with the calculated substitutive value Fa, and to S120, in which it is determined whether the replaced compression force F is equal to or greater than the set compression force Fs.

When the result in S120 is YES, the program goes to S122, wherein the processing is the same as that in S32 of FIG. 4 shown in the first embodiment. On the other hand, when the result in S120 is NO, i.e., when the compression force F replaced with the substitutive value Fa calculated based on the stress-relaxation time τ of the resin 30 becomes less than the set compression force Fs within the flow cessation determination period (predefined time period) ts, the program goes to S 124, in which the value of the count i is reset.

Next, in S126, the compression force F at that time (t+Δt) is controlled constantly to the set compression force Fs, i.e., the compression force F is increased, while the upper die 22a is again lowered to die-clamp the resin 30 and analyze its flow, and the die-clamping speed at that time is calculated.

To explain the aforesaid processing concretely, first, the upper die 22a is lowered at a virtual speed Vp, the flow behavior of the resin 30 under the compression at this time is analyzed, and the stress σ and compression force F occurring at the individual elements of the resin 30 are calculated by the finite element method. When the value of the calculated compression force F is a value equal (more exactly, within a range recognized as equal) to the set compression force Fs, the virtual speed Vp is defined (calculated) as the die-clamping speed V at that time t.

On the other hand, when it is determined that the value of the compression force F is not within the range recognized as equal to the set compression force Fs, the virtual speed Vp is appropriately modified, the value of the compression force F is controlled to a value within the range recognized as equal to the set compression force Fs, and the die-clamping speed V at that time t is defined (calculated).

Next, after updating the time t in S 128, the program goes to S130, in which it is determined whether the die-clamping speed V calculated in S126 is greater than zero.

When the result in S130 is YES, i.e., when it is determined that the recompression associated with the stress-relaxation phenomenon is in progress, the aforesaid processing is repeated. On the other hand, when the result in S130 is NO, i.e., when it is determined that the upper die 22a has again stopped, the value of the count i is incremented in S132, whereafter the program goes to S114 to repeat the foregoing processing until it can be determined that die-clamping has reached completion, and then to S134, in which it is determined that flow analysis of the resin 30 has completed. Transition to pressure-holding/cooling analysis or the like is performed as required.

Being configured as set out above, the computer-aided die design apparatus 10 according to the second embodiment can, similarly to the first embodiment, determine die-clamping completion with good precision and thus enhance the accuracy of the flow behavior analysis of the resin 30, and since it can further enable analysis under conditions of operation with compression force control, it has the effect of enabling optimum conditions to be defined in accordance with the resin properties.

As stated above, the embodiments of this invention is configured to have a computer-aided die design apparatus (10) having a computer (12), a display (14) adapted to be connected to the computer, and a simulator (simulation program 16) adapted to be loaded in the computer to analyze and display on the display flow behavior of resin when the resin charged into a die cavity is die-clamped by a press at a compression force (F), wherein the simulator comprises: an analyzer (or the simulation program is programmed to analyze; S10-S20, S100-S110) that analyzes the resin flow behavior by increasing the compression force (F) for die-clamping the resin at a predetermined time interval until the increased compression force reaches an upper limit value (Fmax, Fs); and a substitutive value calculator (or to calculate; S24-S28, S114-S118) that calculates a substitutive value of the compression force (Fa) based on a stress-relaxation time of the resin when the compression force has reached the upper limit value. With this, it becomes possible to calculate the compression force F required for die-clamping the resin 30 accurately, thereby enabling improvement of the accuracy of the resin flow behavior analysis.

In the apparatus, the simulator further includes: a compression force replacer (the simulation program is further programmed to replace; S28, S118) that replaces the compression force with the calculated substitutive value of the compression force; and an analysis completion determiner (or to determine; S32, S42, S122, S132) that determines that the analyzing of the resin flow behavior has completed when the replaced substitutive value of the compression force is kept equal to or greater than the upper limit value for a predefined time period (ts). With this, it becomes possible to enable accurate determination of the die-clamping completion and improvement of the accuracy of the resin flow behavior analysis.

In other words, it is configured so that the simulation program does not determine that the die-clamping is completed until the predetermined time period is has elapsed since the compression force F replaced with the substitutive value Fa calculated based on the stress-relaxation time τ of the resin 30 reaches the upper limit value (Fmax or Fs). With this, it becomes possible to accurately determine the die-clamping completion and to improve the accuracy of the resin flow behavior analysis.

In the apparatus, the simulator further includes: a second analyzer (or the simulation program is further programmed to analyze; S30, S34-S40, S126-S130) that analyzes the resin flow behavior by increasing the replaced substitutive value of the compression force at a prescribed time interval until the replaced substitutive value of the compression force reaches the upper limit value, when the replaced substitutive value of the compression force becomes less than the upper limit value within the predefined time period. With this, in addition to the aforesaid effects, it is possible to further improve the accuracy of the resin flow behavior analysis.

In the apparatus, the substitutive value calculator calculates (or the step of substitutive value calculation is programmed to calculate) a stress in accordance with an equation expressed by:

σ=σ0 exp (−tr/τ),

(where σ0: stress at an instant when the die-clamping is stopped; τ: a resin stress-relaxation time; and tr: an elapsed time period since the die-clamping was stopped), and calculates the substitutive value of the compression force based on the calculated stress. With this, in addition to the aforesaid effects, it is possible to calculate the substitutive value Fa of the compression force F simply and accurately based on the stress-relaxation time τ.

In the apparatus, the upper limit value (Fmax) is set to a fixed value defined based on characteristics of the press. With this, in addition to the aforesaid effects, it is possible to simplify the configuration.

In the apparatus, the upper limit value (Fs) is set to a variable value. With this, in addition to the aforesaid effects, the analysis accuracy can be further improved by setting suitable conditions in accordance with resin properties.

It should be noted, although in the foregoing, the first analysis means (S14 to S18, S104 to S108) and the second analysis means (S36 to S40, S126 to S130) of the flowchart of FIG. 4 use the same values for the predetermined time increment Δt and the die-clamping speed V, the values can be differentiated.

Moreover, although a configuration is adopted wherein the die-clamping completion (analysis completion) time point is defined as a time point which follows the arrival of the substitutive value Fa of the compression force after occurrence of the stress-relaxation phenomenon (more exactly, the replaced compression force F) at the upper limit value (Fmax, Fs) and at which this state has continued for the predefined time ts, it can instead be defined, as shown in FIG. 5, as a time point following occurrence of the stress-relaxation phenomenon at which the resin reaches a predetermined thickness (designated thickness) designated in advance with consideration to the stress-relaxation phenomenon.

Further, although in the foregoing embodiments explanation was made with respect to a computer-aided die design apparatus that simulates resin flow behavior when molding a flowable resin by a press (compression) molding, the configuration explained above can also be used for a computer-aided die design apparatus that simulates resin flow behavior when molding by an injection-compression molding that compresses a molten resin injected into a die with an injection mechanism.

Japanese Patent Application No. 2013-062209, filed on Mar. 25, 2013, is incorporated by reference herein in its entirety.

While the invention has thus been shown and described with reference to specific embodiments, it should be noted that the invention is in no way limited to the details of the described arrangements; changes and modifications may be made without departing from the scope of the appended claims.

What is claimed is:

1. A computer-aided die design apparatus having a computer, a display adapted to be connected to the computer, and a simulator adapted to be loaded in the computer to analyze and display on the display flow behavior of resin when the resin charged into a die cavity is die-clamped by a press at a compression force,
wherein the simulator comprises:
an analyzer that analyzes the resin flow behavior by increasing the compression force for die-clamping the resin at a predetermined time interval until the increased compression force reaches an upper limit value; and
a substitutive value calculator that calculates a substitutive value of the compression force based on a stress-relaxation time of the resin when the compression force has reached the upper limit value.

2. The computer-aided die design apparatus according to claim 1, wherein the simulator further includes:
a compression force replacer that replaces the compression force with the calculated substitutive value of the compression force; and
an analysis completion determiner that determines that the analyzing of the resin flow behavior has completed when the replaced substitutive value of the compression force is kept equal to or greater than the upper limit value for a predefined time period.

3. The computer-aided die design apparatus according to claim 2, wherein the simulator further includes:
a second analyzer that analyzes the resin flow behavior by increasing the replaced substitutive value of the compression force at a prescribed time interval until the replaced substitutive value of the compression force reaches the upper limit value, when the replaced substitutive value of the compression force becomes less than the upper limit value within the predefined time period.

4. The computer-aided die design apparatus according to claim 1, wherein the substitutive value calculator calculates a stress in accordance with an equation expressed by:
σ=σ0 exp (−tr/τ),
where σ0: stress at an instant when the die-clamping is stopped; τ: a resin stress-relaxation time; and tr: an elapsed time period since the die-clamping was stopped,
and calculates the substitutive value of the compression force based on the calculated stress.

5. The computer-aided die design apparatus according to claim 1, wherein the upper limit value is set to a fixed value defined based on characteristics of the press.

6. The computer-aided die design apparatus according to claim 1, wherein the upper limit value is set to a variable value.

7. A computer-aided die design apparatus having a computer, a display adapted to be connected to the computer, and a simulation program adapted to be loaded in the computer to analyze and display on the display flow behavior of resin when the resin charged into a die cavity is die-clamped by a press at a compression force,
wherein the simulation program is programmed to
analyze the resin flow behavior by increasing the compression force for die-clamping the resin at a predetermined time interval until the increased compression force reaches an upper limit value; and
calculate a substitutive value of the compression force based on a stress-relaxation time of the resin when the compression force has reached the upper limit value.

8. The computer-aided die design apparatus according to claim 7, wherein the simulation program is further programmed to:
replace the compression force with the calculated substitutive value of the compression force; and
determine that the analyzing of the resin flow behavior has completed when the replaced substitutive value of the compression force is kept equal to or greater than the upper limit value for a predefined time period.

9. The computer-aided die design apparatus according to claim 8, wherein the simulation program is further programmed to:
analyze the resin flow behavior by increasing the replaced substitutive value of the compression force at a prescribed time interval until the replaced substitutive value of the compression force reaches the upper limit value, when the replaced substitutive value of the compression force becomes less than the upper limit value within the predefined time period.

10. The computer-aided die design apparatus according to claim 7, wherein the step to substitutive value calculation is programmed to calculate a stress in accordance with an equation expressed by:
σ=σ0 exp (−tr/τ),
where σ0: stress at an instant when the die-clamping is stopped; τ: a resin stress-relaxation time; and tr: an elapsed time period since the die-clamping was stopped,
and calculate the substitutive value of the compression force based on the calculated stress.

11. The computer-aided die design apparatus according to claim 7, wherein the upper limit value is set to a fixed value defined based on characteristics of the press.

12. The computer-aided die design apparatus according to claim 7, wherein the upper limit value is set to a variable value.
